(19) United States
(12) Patent Application Publication
(10) Pub. No.: US 2007/0260790 A1
(43) Pub. Date: Nov. 8, 2007

(54) Embedded controller and method for updating the firmware thereof

(76) Inventors: Jerry Chen, Hsi-Chih City (TW); W.S. Chen, Hsi-Chih City (TW); Abel Yang, Lu-Hhon City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/395,202

(22) Filed: Apr. 3, 2006

(51) Int. Cl. G06F 13/00

(52) U.S. Cl. 710/110

(57) ABSTRACT

An embedded controller (EC) is a microprocessor having a firmware storage for use in a notebook computer (NB) to control keyboard, touch pad or other user interfaces. When the NB is just powered on or before the south-bridge chip (ICH) is activated, the EC is switched from a slave to a master, and the whole or part of firmware codes can be downloaded from the BIOS storage via LPC/SPI bus. Then, the whole or part of the firmware is updated using an in-circuit programming function of the Firmware Storage. Thereafter, the EC is switched back to the slave, and the NB is powered on or the ICH is activated. It is not necessary to update EC firmware corresponding to different version of BIOS when manufacturing an NB, and unexpected errors encountered during the EC self-updating can be effectively repaired to protect the EC firmware.

### BACKGROUND OF THE INVENTION

1. Field of the Invention

This invention relates to an embedded controller and method for updating its firmware, especially relates to an embedded controller and method for updating its firmware, which is facilitating to effectively solve the problem with updating EC firmware on various BIOS during the production of NB.

2. Description of the Prior Art

There is an embedded controller (EC) installed in the notebook(NB), wherein it is utilizing embedded controller (EC) to control the keyboard, touchpad or other user interfaces, thereat the said EC is employed as a microprocessor equipped with one Firmware Storage and currently there are two major circuits utilized to manage such Firmware Storage, one is the shared memory circuit (SMS), and the other is embedded memory circuit(EMS); and where it's under the SMS architecture, as shown on FIG. 1, the said EC does not have such firmware storage, and instead it is sharing the storage with the BIOS, which means the BIOS could not only store the necessary operational program codes into its storage but also store the program codes for EC as well, and when the south bridge chip (ICH) installed in NB is executing the program code of BIOS, it must run cross the EC in order to read the BIOS program code successfully, therefore, it needs to have a bus arbitration function while it's under the SMS architecture; and where it's under the EMS architecture, as shown on FIG. 2, the said EC has such firmware storage, wherein the said firmware is a flash memory, and under the EMS architecture, the said EC and ICH of NB are responsive to each firmware storage respectively, therefore, it doesn't need any bus arbitration function at all while it's under the EMS architecture. However there are either advantage or disadvantage for both above mentioned known technology, where it's under SMS architecture, although it need not to install firmware storage on EC, but it needs to keep a dramatic large storage space on BIOS storage, in addition, the shared bus architecture meaning a complicated IC designing; and while it's under EMS architecture, although it doesn't have the same defect as SMS, but it's very difficult to update EC firmware corresponding to various BIOS. Thus, how to smoothly update the EC firmware corresponding to various BIOS has become today's issue.

In light of the above, there are still a lot of defects and shortages from above-mentioned known technology, so frankly speaking, it is not a good designing at all, and therefore it needs to be improved without any ambiguity.

Due to the various defects and shortages developed from above-mentioned known technology, therefore the inventor of this invention has spent lots of time and money in studying all the relevant improvements for many years, and finally he has succeeded in creating an embedded controller and method for updating its firmware.

### SUMMARY OF THE INVENTION

The object of this invention is to provide an embedded controller and method for updating its firmware, where it can effectively resolve the problem on updating firmware for embedded controller according to various versions of BIOS while on the production of NB.

An applicable embedded controller with method for updating its firmware to fulfill the above object of this invention, wherein it is utilizing embedded controller (EC) to control the keyboard, touchpad or other user interfaces, thereat the said EC is employed as a microprocessor equipped with one Firmware Storage and implemented in a notebook(NB); the said embedded controller is acting as a multiple master and slave devices, by the time while starting NB or south-bridge chip (ICH) still inactivating, such EC is switching from a slave device to a master device, so NB can download partial or the whole firmware programs from BIOS storage via LPC/SPI bus, and then updating the partial or whole firmware by means of in-circuit programming function of such embedded Firmware Storage; and after updating the EC's firmware, NB could be switched from a master device back to a slave device, and then powering on such NB or activating ICH accordingly.

### BRIEF DESCRIPTION OF THE DRAWINGS

For a fuller understanding of the nature and objects of the invention, reference should be had to the following detailed description taken in connection with the accompanying drawings, in which:

FIG. 1 is an implemented architecture view of known shared memory circuit simulation (SMS);

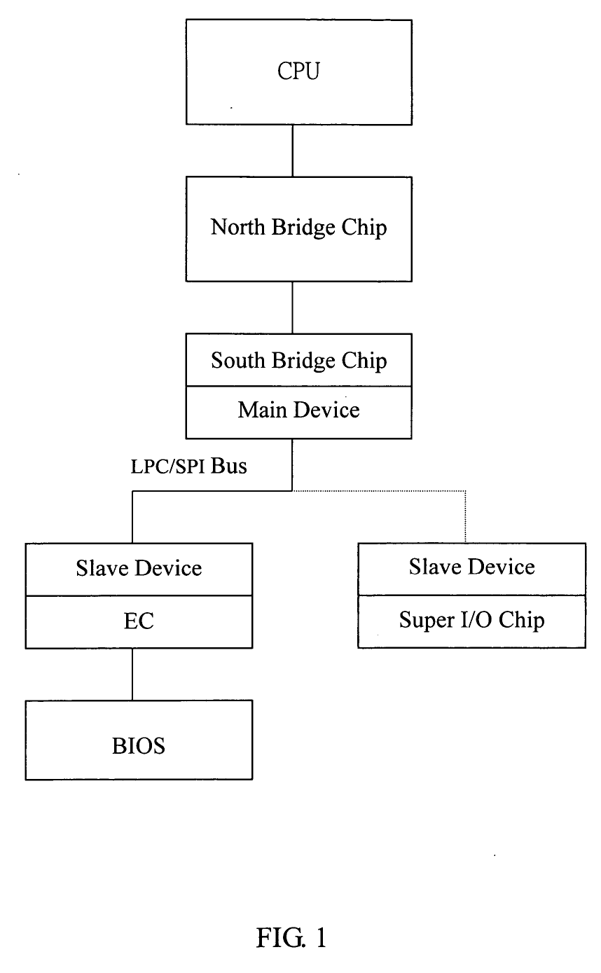

FIG. 2 is an implemented architecture view of known embedded memory circuit simulation (EMS);

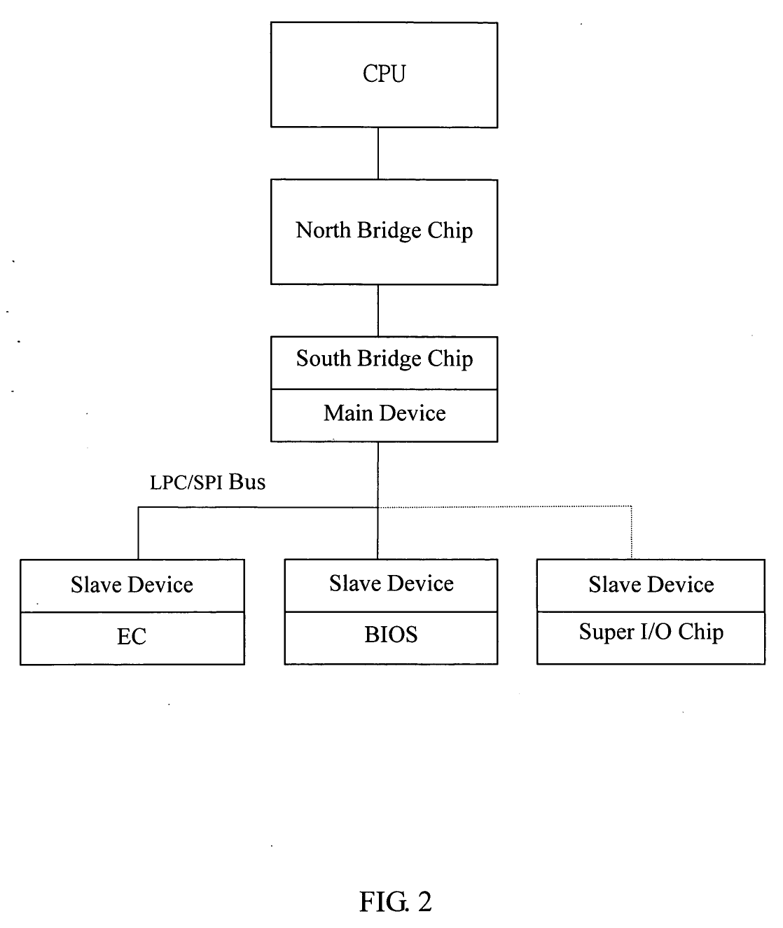

FIG. 3 is an implemented architecture view of an embedded controller and method for updating new firmware provided by this invention;

FIG. 4 is an updating flow chart of an embedded controller and method for updating its firmware.

Similar reference characters refer to similar parts throughout the several views of the drawings.

### DETAILED DESCRIPTION OF THE PREFERRED EMBODIMENTS

Hereinafter, the present invention will be described by way of illustrative examples with reference to the accompanying drawings.

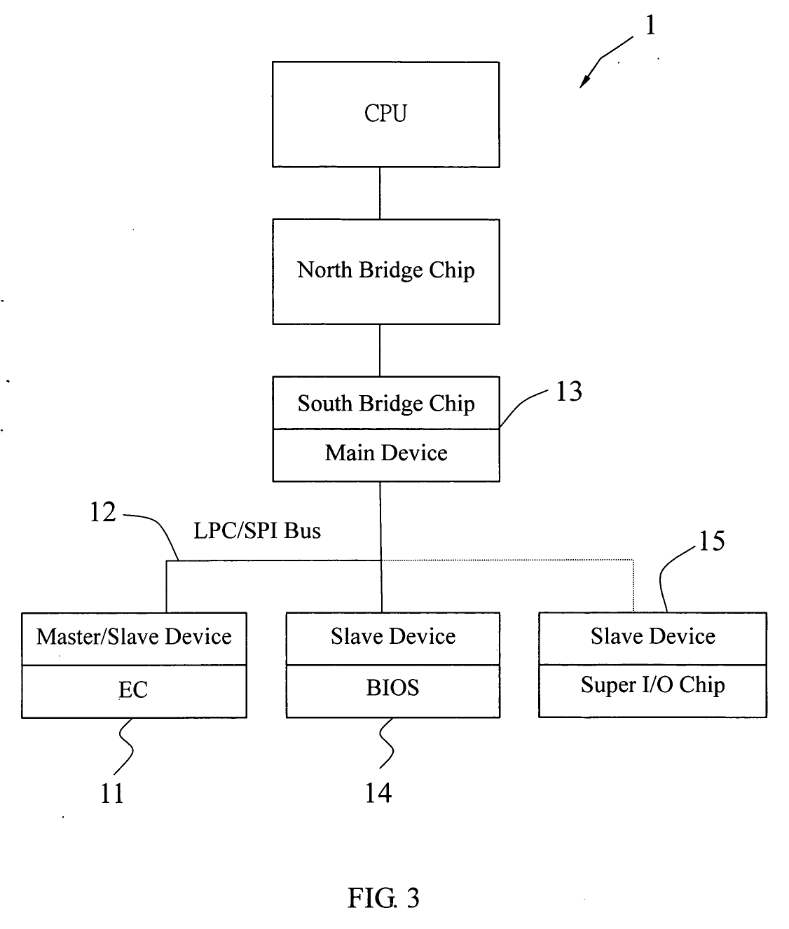

With reference to FIG. 3, it is an implemented architecture view of an embedded controller and method for updating new firmware provided by this invention; and according to this invention, wherein an embedded controller 11 has been installed into a NB architecture 1, and thereat the said embedded controller 11 is capable to connect to the South Bridge Chip (ICH)13, BIOS Storage 14, Super I/O chip 15 as well as other units via one LPC/SPI bus 12; after modifying EC from a simple slave device to act as a multiple master and slave devices by this invention, and by the time while starting NB or south-bridge chip (ICH) still inactivating, the said EC is switching from a slave device to a master device, so EC can download partial or the whole firmware programs from BIOS storage via LPC/SPI bus, and then updating the partial or whole firmware by means of in-circuit programming function of such embedded Firmware Storage in EC; and after updating the EC's firmware, EC could be switched from a master device back to a slave device, and then powering on such NB or activating ICH accordingly. This invention is applicable to various firmware storages with read/write function together with In-Circuit Programming (ICP), such as: Flash memory.

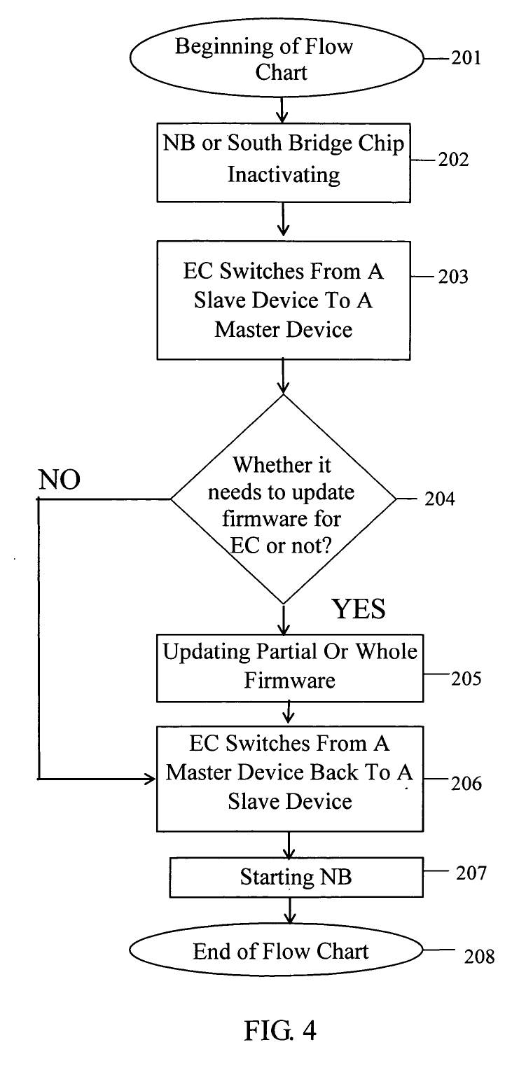

With reference to the FIG. 4, it is an updating flow chart of an embedded controller and method for updating its firmware of this invention, and according to such diagram, at the beginning 201 of the flow chart, the said NB or the south bridge chip (ICH) in inactivating 202 yet, and at this moment, the embedded control is switching from a slave device to a master device 203, so as to determine whether it's necessary to update the firmware or not 204? Additionally, it will start updating the partial or whole firmware 205 if it is necessary to update it, and then after updating, EC will switch from a slave device to a master device 206, as well as starting the NB continuously 207, and finally it's the end of such flow chart 208.

In light of the detailed description of the preferred embodiment set forth above which in fact is just one of the preferred embodiments of this invention only, since certain changes may be made in the above article without departing from the scope of the invention, it is intended that all matter contained in the above description or shown in the accompanying drawings shall be interpreted as illustrative and not in a limiting sense. It is also to be understood that the following claims are intended to cover all of the generic and specific features of the invention herein described, and all statements of the scope of the invention which, as a matter of language, might be said to fall there between.

What is claimed is:

1. An embedded controller is installed i n t o a notebook computer's computer systematic architecture, wherein the said embedded controller is acting as a multiple master and slave devices, wherein the said embedded controller is connecting to south bridge chip, BIOS Storage, Super I/O chip and other user interfaces via LPC/SPI bus.

2. An embedded controller as claimed in claim 1, wherein said embedded controller is applicable to such Firmware Storage with read/write function as well as in-circuit programming capability.

3. An embedded controller as claimed in claim 2, wherein said Firmware Storage is applicable of a flash memory.

4. An embedded controller and method for updating its firmware, wherein the said embedded controller is switching from a slave device to a master device by the time while starting NB or south-bridge chip (ICH) still inactivating, therefore such EC can download partial or the whole firmware programs from BIOS storage via LPC/SPI bus, and with a built-in in-circuit programming function of embedded firmware storage of the said embedded controller, thereat the partial or whole firmware programs will be updated accordingly, and then the said embedded controller would be able to switch from a master device back to a slave device after updating its firmware, and then it will power on such NB or activate south-bridge chip (ICH) accordingly.
